(19) United States
(12) Patent Application Publication
(10) Pub. No.: US 2024/0278376 A1
(43) Pub. Date: Aug. 22, 2024

(54) PORTABLE MACHINING APPARATUS

(71) Applicant: MAKITA CORPORATION, Anjo-shi (JP)

(72) Inventor: Tsuyoshi KURODA, Anjo-shi (JP)

(73) Assignee: MAKITA CORPORATION, Anjo-shi (JP)

(21) Appl. No.: 18/423,872

(22) Filed: Jan. 26, 2024

(30) Foreign Application Priority Data
Feb. 16, 2023 (JP) 2023-022201

(51) Int. Cl. B24B 23/02; B24B 41/00; B24B 47/12; B24B 55/10; B25F 5/00

(52) U.S. Cl. CPC B24B 23/02; B24B 41/007; B24B 47/12; B24B 55/102; B25F 5/008

(57) ABSTRACT

A portable machining apparatus includes a motor, an output shaft extending in an axial direction and configured to be rotated by a rotational driving force of the motor, a tool accessory configured to perform an eccentric circular motion in response to the rotation of the output shaft, a dust collection fan fixed to the output shaft so as to circumferentially surround the output shaft, a motor cooling fan configured to be rotated by the rotational driving force of the motor, and a balancer attached to at least one fan of the dust collection fan and the motor cooling fan. A flow passage is formed so as to radially outward exhaust air flowing in the axial direction toward the at least one fan at a circumferential position between an edge portion opposite from the balancer in the axial direction and the balancer at which position the balancer is attached.

### TECHNICAL FIELD

The present disclosure relates to a portable machining apparatus.

### BACKGROUND

One conventionally known type of portable machining apparatus is an orbital sander. The orbital sander causes a pad coupled at one end of an output shaft (for example, a motor shaft) to perform an eccentric circular motion (an orbital motion). Sanding paper is attached to the pad. Sanding work can be performed by pressing the sanding paper against a machining target.

Such an orbital sander is subjected to a vibration generated along with the eccentric circular motion of the pad. U.S. Pat. No. 9,545,712 discloses a technique for solving a static unbalance and a couple unbalance with the aid of provision of balancers attached to a circumferential part of a fan (a fan into which a dust collection fan and a motor cooling fan are integrated) fixed around an output shaft to reduce such generation of a vibration.

### SUMMARY

The present specification discloses a portable machining apparatus. This portable machining apparatus may include a motor, an output shaft extending in an axial direction and configured to be rotated by a rotational driving force of the motor, a tool accessory configured to perform an eccentric circular motion in response to the rotation of the output shaft, a dust collection fan fixed to the output shaft so as to circumferentially surround the output shaft, a motor cooling fan configured to be rotated by the rotational driving force of the motor, and a balancer attached to at least one fan of the dust collection fan and the motor cooling fan. A flow passage may be defined so as to radially outward exhaust air flowing in the axial direction toward the at least one fan at a circumferential position of the at least one fan between an edge portion of the at least one fan opposite from the balancer in the axial direction and the balancer at which position the balancer is attached.

According to the above-described configuration, even in the circumferential region of the at least one fan where the balancer is disposed, the air flowing along the output shaft can be guided radially outward via the flow passage between the edge portion of the at least one fan axially opposite from the balancer, and the balancer. Therefore, a change in the pressure of the air according to the rotation of the at least one fan is reduced. As a result, the generation of noise is reduced. In addition, dust is also guided radially outward together with the air with the aid of this flow passage, and therefore can be prevented from being accumulated in a space between the balancer and the at least one fan.

### BRIEF DESCRIPTION OF THE DRAWINGS

FIG. 1 is a perspective view of a sander according to one embodiment.

FIG. 2 is a plan view of the sander.

FIG. 3 is a left side view of the sander.

FIG. 4 is a partial enlarged cross-sectional view taken along a line A-A illustrated in FIG. 2.

FIG. 5 is a partial enlarged cross-sectional view taken along the line A-A illustrated in FIG. 2.

FIG. 6 is a perspective view of a fan as viewed from one side where a dust collection fan is located.

FIG. 7 is a perspective view of the fan as viewed from one side where a motor cooling fan is located.

FIG. 8 is a bottom view of the dust collection fan.

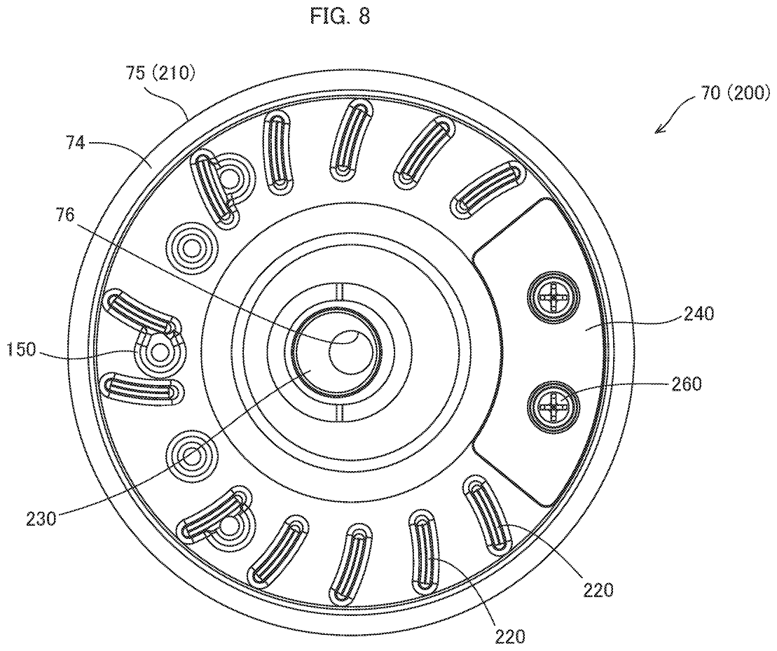

FIG. 9 is a bottom view of the dust collection fan, and indicates the structure of the opposite side of a balancer with broken lines.

FIG. 10 is an exploded perspective view of the dust collection fan.

FIG. 11 is a perspective view of the balancer for the dust collection fan.

### DETAILED DESCRIPTION OF THE EMBODIMENTS

Representative and non-limiting specific examples of the present invention will be described in detail below with reference to the drawings. This detailed description is merely intended to teach a person of skill in the art details for practicing preferred examples of the present invention and is not intended to limit the scope of the present invention. Furthermore, each of additional features and inventions disclosed below can be utilized separately from or together with the other features and inventions to provide further improved apparatuses and methods for manufacturing and using the same.

Moreover, combinations of features and steps disclosed in the following detailed description are not necessary to practice the present invention in the broadest sense, and are instead taught merely to particularly describe a representative specific example of the present invention. Furthermore, various features of the above-described and the following representative examples, as well as various features recited in the independent and dependent claims below, do not necessarily have to be combined in herein specifically exemplified manners or enumerated orders to provide additional and useful embodiments of the present invention.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges and indications of groups or aggregations are intended to disclose every possible intermediate individual forming them for the purpose of original written disclosure, as well as for the purpose of restricting the claimed subject matter.

In one or more embodiments, the at least one fan may include a main plate and a plurality of blades generally radially extending at least partially on one of surfaces of the main plate. The one of the surfaces may be a surface on one side of the main plate where the balancer is located. The flow passage may be defined between the one of the surfaces of the main plate and the balancer. According to this configuration, a flow passage for radially outward exhausting the air flowing along the output shaft can be defined with a simple structure. “Generally radially extending at least partially” means generally radially extending on at least a part of circumferential angular positions. “Generally” radially extending is intended to mean that the direction in which the plurality of blades extends may be angled with respect to the exact radial direction.

In one or more embodiments, one of the main plate and the balancer may include a protrusion portion extending toward the other of the main plate and the balancer and placed in abutment with the other of the main plate and the balancer. A space functioning as the flow passage may be defined between the main plate and the balancer using the protrusion portion. According to this configuration, a flow passage for radially outward exhausting the air flowing along the output shaft can be defined with a further simple structure.

In one or more embodiments, the protrusion portion may be shaped to function as a rectifier for radially outward directing a flow of the air in the flow passage. According to this configuration, the radially outward flow of the air in the flow passage is promoted. Therefore, the generation of noise and the accumulation of dust can be further reduced.

In one or more embodiments, each of the plurality of blades may at least partially and generally radially extend so as to intersect with a radial direction. The protrusion portion may be disposed so as to intersect with the radial direction in the same direction as the plurality of blades. According to this configuration, the radially outward flow of the air in the flow passage is further promoted. Therefore, the generation of noise and the accumulation of dust can be further reduced.

In one or more embodiments, the balancer may include the protrusion portion. According to this configuration, the balancer increases in weight compared to a configuration in which the main plate of the at least one fan includes the protrusion portion. Therefore, the balancer can be set up in a compact area on a horizontal surface perpendicular to the axial direction.

In one or more embodiments, the dust collection fan and the motor cooling fan may be in the form of an integrated single fan including a main plate including a first surface and a second surface opposite from the first surface, a plurality of first blades radially extending at least partially on the first surface, and a plurality of second blades radially extending at least partially on the second surface. According to this configuration, the number of parts and the number of assembling processes of the portable machining apparatus can be reduced.

In one or more embodiments, the balancer may be made from metal. The at least one fan may be lighter in specific gravity than the balancer. According to this configuration, the weight difference can increase between the at least one fan and the balancer, and therefore the static unbalance and the couple unbalance can be efficiently solved. Alternatively, the required weight difference can be secured with a relatively small volume of the balancer, and therefore the balancer can be configured compactly.

In one or more embodiments, the at least one fan may include a threaded boss protruding toward the balancer. The balancer may include a through-hole at a position corresponding to the threaded boss. The protrusion portion may protrude toward the at least one fan around the through-hole, and is shaped and sized in such a manner that an outer periphery of the threaded boss is fitted therein. The at least one fan and the balancer may be fixed to each other using a threaded member inserted in the through-hole and the threaded boss. According to this configuration, a flow passage for radially outward exhausting the air can be defined with a simple structure, and the balancer can be accurately and easily positioned relative to at least one fan. In other words, the protrusion portion can fulfill both the two functions.

In the following description, a sander 10 as one exemplary embodiment will be described in further detail with reference to the drawings. The sander 10 is also called a random orbit sander.

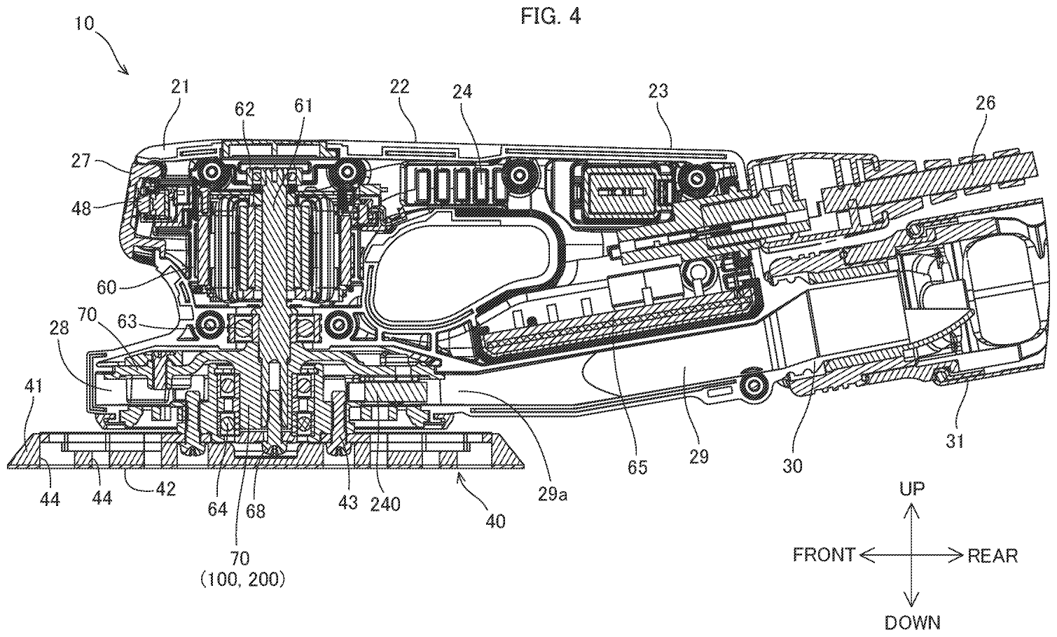

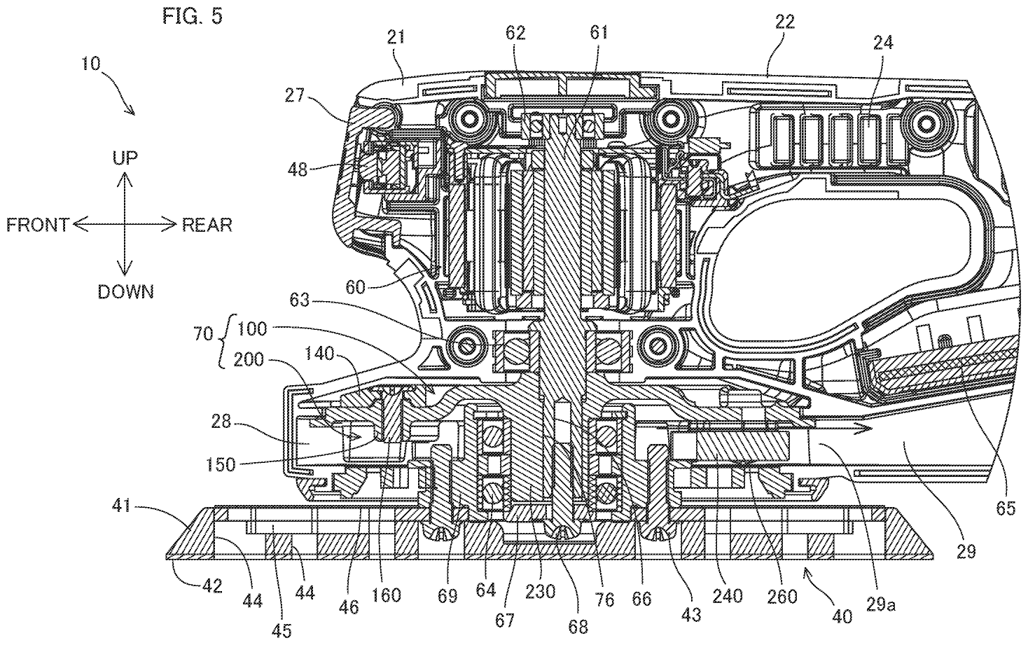

As illustrated in FIGS. 4 and 5, the sander 10 includes an electric motor 60, a motor shaft 61, and a tool accessory 40. One end of the motor shaft 61 is coupled with the tool accessory 40 via another member. As will be described in detail below, the sander 10 is configured in such a manner that the tool accessory 40 performs a sanding motion by a rotation of the electric motor 60 (the motor shaft 61).

In the following description, a direction in which the motor shaft 61 extends is defined to be a vertical direction of the sander 10. One side in the vertical direction on which the tool accessory 40 is located is defined to be a lower side, and the opposite side therefrom is defined to be an upper side. Further, the longitudinal direction of the sander 10 perpendicular to the vertical direction is defined to be a front-rear direction of the sander 10. One side in the front-rear direction on which the tool accessory 40 is located is defined to be a front side, and the opposite side therefrom is defined to be a rear side. Further, a direction perpendicular to the front-rear direction and the vertical direction is defined to be a left-right direction of the sander 10. A right side in the left-right direction when the front side is viewed from the rear side is defined to be a right side of the sander 10, and the opposite side therefrom is defined to be a left side of the sander 10.

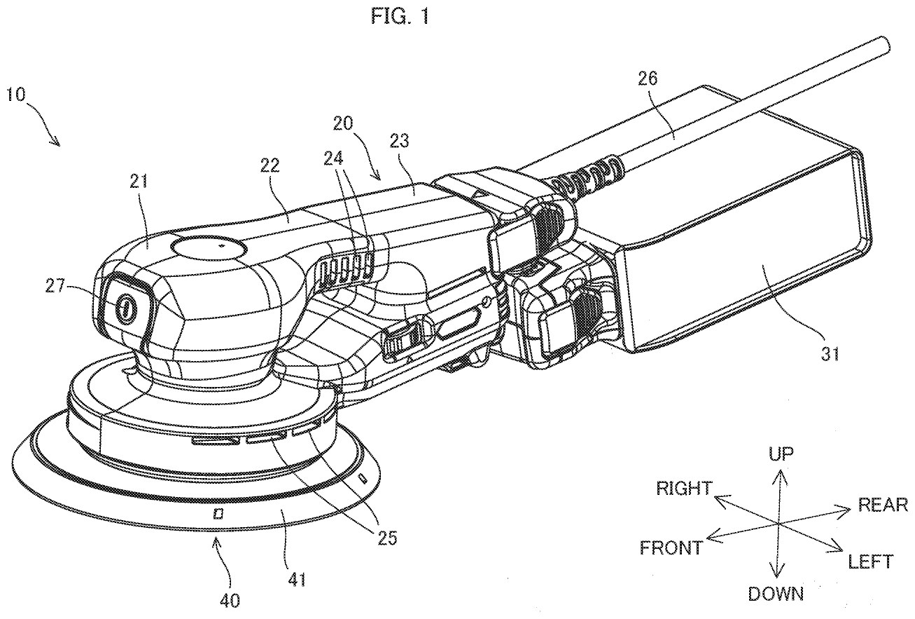

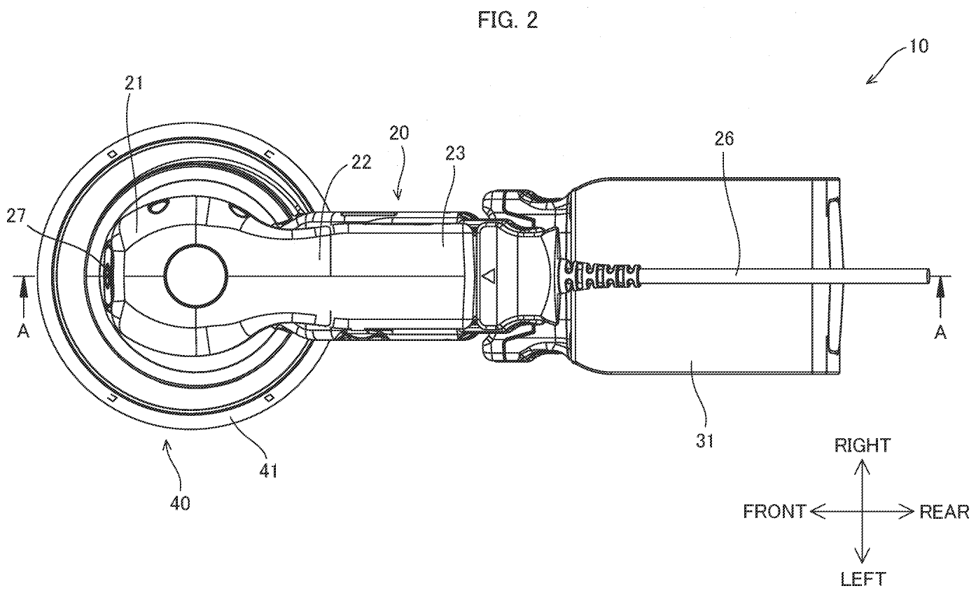

As illustrated in FIGS. 1 to 3, the sander 10 includes a housing 20. The housing 20 includes a front housing portion 21, a grip portion 22, and a rear housing portion 23. The front housing portion 21 and the rear housing portion 23 are coupled in the front-rear direction via a vertically separated forked form, and an upper-side coupling portion functions as the grip portion 22. A power source cord 26, which is used to supply power to the electric motor 60, extends out of the rear edge of the rear housing portion 23.

As illustrated in FIG. 4, a controller 65 is contained in the lower portion of the rear housing portion 23. The controller 65 is electrically connected to the power source cord 26 and the electric motor 60, and controls the operation of the electric motor 60 by controlling power to be supplied to the electric motor 60. As illustrated in FIG. 1, a switch button 27 is provided at the front portion of the front housing portion 21. The switch 27 is used to perform an operation of starting up and stopping the electric motor 60. A switch unit 48 is disposed behind the switch button 27 in an interlockable manner. The switch unit 48 is electrically connected to the controller 65.

As illustrated in FIGS. 4 and 5, the electric motor 60 is contained in the front housing portion 21. The motor shaft 61 of the electric motor 60 extends vertically, and is rotatably supported via bearings 62 and 63 fixed to the front housing portion 21. The bearing 62 supports the upper end of the motor shaft 61, and the bearing 63 supports near the lower end of the motor shaft 61.

A fan 70 is disposed below the bearing 63. The fan 70 is fixed to the motor shaft 61 so as to circumferentially surround the motor shaft 61. In the present embodiment, the fan 70 has both a function as a motor cooling fan and a function as a dust collection fan. More specifically, the upper-side portion of the fan 70 functions as a motor cooling fan and the lower-side portion of the fan 70 functions as a dust collection fan. Therefore, in the following description, the upper-side portion of the fan 70 will also be referred to as a motor cooling fan 100 and the lower-side portion of the fan 70 will also be referred to as a dust collection fan 200.

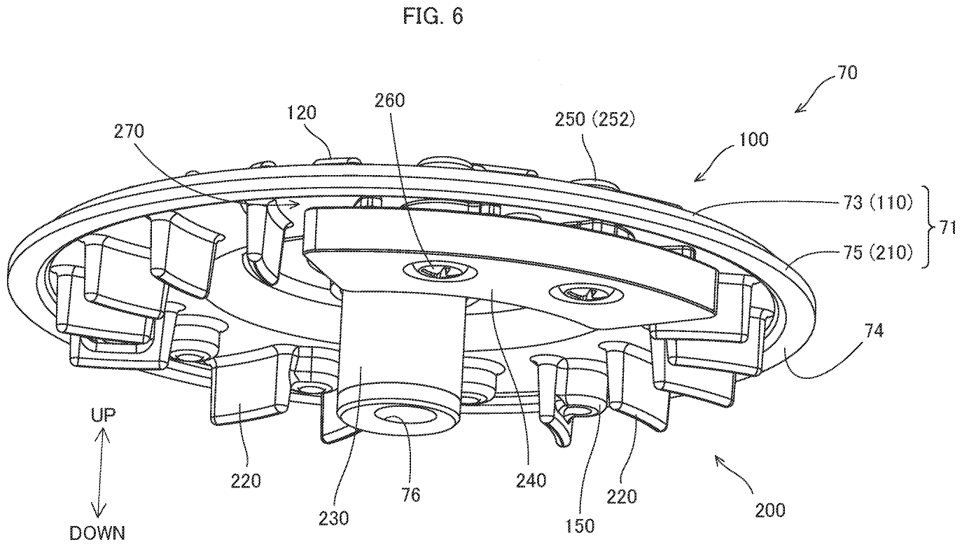

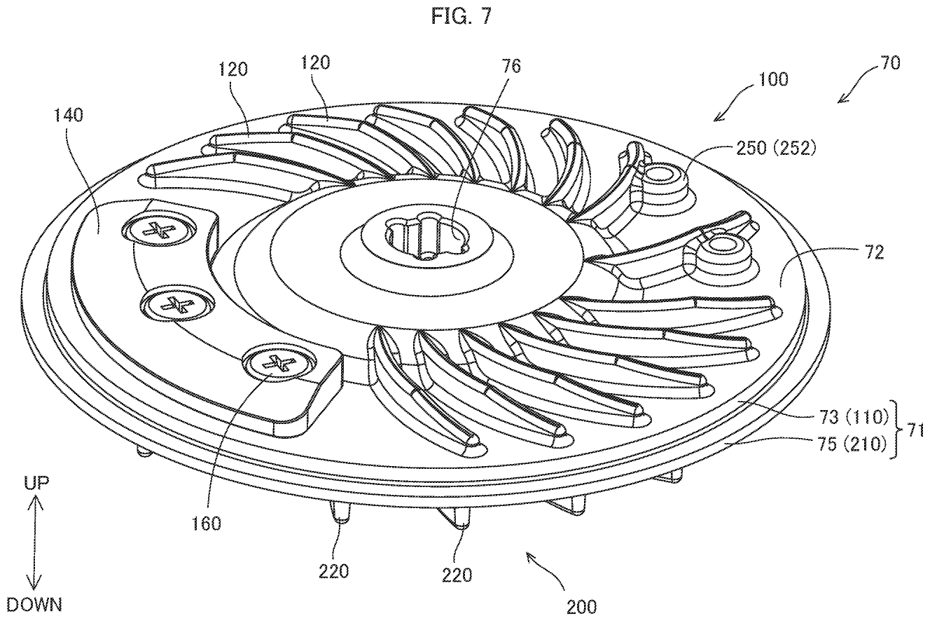

As illustrated in FIGS. 6 and 7, the fan 70 includes a disk-shaped main plate 71. A shaft insertion hole 76, which vertically extends through the fan 70, is formed at the center of the main plate 71. The motor shaft 61 is inserted through the shaft insertion hole 76. The main plate 71 includes an upper-side portion 73, which has an upward facing first surface 72, and a lower-side portion 75, which has a downward facing second surface 74. The upper-side portion 73 functioning as a part of the motor cooling fan 100 will also be referred to as a main plate 110. The lower-side portion 75 functioning as a part of the dust collection fan 200 will also be referred to as a main plate 210. In the present embodiment, the upper-side portion 73 and the lower-side portion 75 are one member integrally formed without using secondary gluing or mechanical joining, but may be glued by any method or may be mechanically joined. In the present embodiment, the radius of the lower-side portion 75 is slightly larger than the radius of the upper-side portion 73. A stepped portion is formed by that, and a flow of air between spaces above and below the main plate 71 is impeded due to the provision of a rib horizontally extending from the inner surface of the front housing portion 21 at this stepped portion.

As illustrated in FIG. 7, a plurality of first blades 120 generally radially extends partially (i.e., at predetermined angular positions) on the main plate 110 (the first surface 72) of the motor cooling fan 100. In the present embodiment, the direction in which the first blades 120 extend is angled with respect to the radial direction.

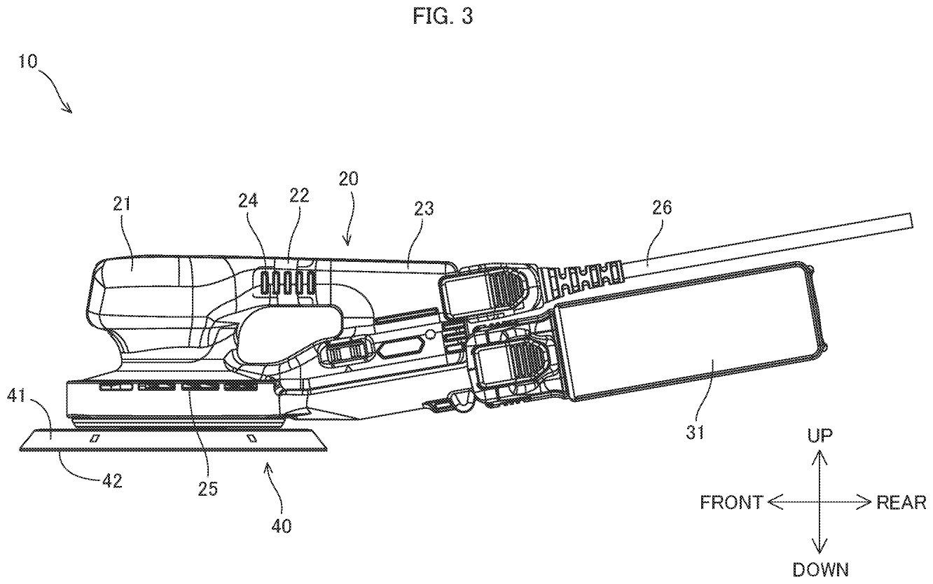

When the fan 70 (the motor cooling fan 100) is rotated in response to the rotation of the motor shaft 61, air flows into the housing 20 from outside thereof via intake ports 24 formed on the grip portion 22 (refer to FIGS. 1 and 3). This air passes through the electric motor 60 and flows axially (the direction in which the motor shaft 61 extends), and reaches the motor cooling fan 100. At the motor cooling fan 100, the downward air flow hits against the main plate 110 and is directed radially outward with the aid of the function of the first blades 120, and is then exhausted out of the housing 20 via exhaust ports 25 formed on the front housing portion 21 (refer to FIGS. 1 and 3). The electric motor 60 is cooled by means of such a flow of the air. The exhaust ports 25 are formed at vertical positions corresponding to the motor cooling fan 100.

As illustrated in FIG. 6, the dust collection fan 200 includes a shaft portion 230. The shaft portion 230 protrudes cylindrically downward from the main plate 210 around the center of the main plate 210. The shaft insertion hole 76 is formed inside the shaft portion 230. A plurality of second blades 220 generally radially extends partially (i.e., at predetermined angular positions) on the main plate 210 (the second surface 74) of the dust collection fan 200 on the radially outer side with respect to the shaft portion 230. In the present embodiment, the direction in which the second blades 220 extend is angled with respect to the radial direction.

As illustrated in FIG. 5, the shaft portion 230 is rotatably supported by a bearing 64. A threaded hole 66 is formed in the motor shaft 61. The threaded hole 66 extends from the lower end toward the upper end of the motor shaft 61. A plate 67 is disposed below the shaft portion 230 with the lower end of the motor shaft 61 inserted in the shaft insertion hole 76. At this time, the plate 67 is in abutment with the lower end of the bearing 64. A through-hole is formed on the plate 67 at a position corresponding to the threaded hole 66. The fan 70 is vertically sandwiched between an inner race of the bearing 64 and an inner race of the bearing 63 by inserting a bolt 68 into this through-hole and the threaded hole 66 from below and tightening it. Due to that, the positional relationship between the motor shaft 61, the fan 70, the bearing 63, and the bearing 64 is fixed.

In such an attached state, the shaft portion 230 of the dust collection fan 200 is eccentric with respect to the motor shaft 61 as illustrated in FIG. 5. Therefore, the bearing 64 is eccentric with respect to the motor shaft 61.

As illustrated in FIGS. 4 and 5, a containing space 28 for the dust collection fan 200 in the front housing portion 21 is in communication with a dust collection passage 29 extending in the front-rear direction in the lower portion of the rear housing portion 23. The containing space 28 and the dust collection space 29 are connected via an inlet 29a located at the rearmost portion of the containing space 28. As illustrated in FIG. 4, the dust collection passage 29 is in communication with a dust collection nozzle 30. The dust collection nozzle 30 cylindrically extends rearward from an edge portion of the rear housing portion 23 on the lower side thereof and the rear side. As illustrated in FIGS. 1 and 4, a dust bag 31 is detachably mounted on the dust collection nozzle 30.

As illustrated in FIGS. 1 to 3, the tool accessory 40 is located at the lowermost portion of the sander 10, and includes a pad 41. The pad 41 is circular as viewed vertically. The pad 41 includes a flat surface 42 for attaching sanding paper (not illustrated). The flat surface 42 is the bottom surface of the pad 41, and extends horizontally (in a direction perpendicular to the vertical direction). As illustrated in FIG. 5, the pad 41 is coupled with a bearing box 69 supporting the bearing 64 using a bolt 43.

As illustrated in FIGS. 4 and 5, a plurality of upward extending holes 44 is formed on the bottom surface of the pad 41. The plurality of holes 44 is in communication with a horizontally extending space 45 in the upper portion of the pad 41. The space 45 is in communication with a communication hole 46 formed on the top surface of the pad 41. The communication hole 46 is opened toward an opening on the bottom surface of the front housing portion 21. The opening on the bottom surface of the front housing portion 21 is in communication with the containing space 28, which contains the dust collection fan 200. The sanding paper (not illustrated) is attached to the bottom surface of the pad 41. Holes are formed on the sanding paper at positions corresponding to the holes 44 of the pad 41.

When the fan 70 (the dust collection fan 200) is rotated in response to the rotation of the motor shaft 61, air entraining dust passes through the holes of the sanding paper, the holes 44, the space 45, and the communication hole 46, and flows into the containing space 28. At this time, the air hits against the main plate 210 of the dust collection fan 200, and is guided radially outward with the aid of the function of the second blades 220 of the dust collection fan 200. The air directed in this manner enters the dust collection passage 29 via the inlet 29a, and passes through the dust collection nozzle 30 to flow into the dust bag 31. The dust generated at the time of sanding work can be collected into the dust collection bag 31 with the aid of this flow of the air.

The above-described sander 10 operates in the following manner. First, when the user operates the switch button 27 to drive the electric motor 60, the motor shaft 61 starts to rotate. The rotation of the motor shaft 61 is transmitted to the bearing box 69 supporting the bearing 64 via the bearing 64 eccentric with respect to the motor shaft 61. Therefore, the bearing box 69 and the tool accessory 40 coupled with the bearing box 69 carry out an eccentric circular motion and a rotational motion. When the sanding paper attached to the flat surface 42 of the pad 41 is pressed against a machining target in this state, the machining target is sanded.

Such an eccentric circular motion of the tool accessory 40 causes generation of a vibration. Therefore, the sander 10 includes a configuration for solving a static unbalance and a couple unbalance and thus reducing the generation of a vibration due to the provision of a balancer 140 and a balancer 240 respectively attached to the motor cooling fan 100 and the dust collection fan 200. In the following description, such a configuration will be described.

As illustrated in FIG. 7, the balancer 140 is attached to a circumferential part of the motor cooling fan 100 (a region without the first blades 120 formed thereon). More specifically, a threaded boss 150 is formed on the main plate 71. As illustrated in FIG. 5, the threaded boss 150 protrudes upward and downward on both one side where the motor cooling fan 100 is located and the other side where the dust collection fan 200 is located, respectively. The balancer 140 is fixed to the motor cooling fan 100 as illustrated in FIG. 7 by inserting a bolt 160 into the threaded boss 150 from above so as to place it through a through-hole of the balancer 140 and tightening it. As illustrated in FIG. 5, the balancer 140 includes a recessed portion fittable to an upward protruding portion of the threaded boss 150. Therefore, the balancer 140 can be easily positioned relative to the main plate 110. No space is defined between the balancer 140 and the first surface 72 of the main plate 110 as illustrated in FIG. 7 with the balancer 140 attached to the motor cooling fan 100.

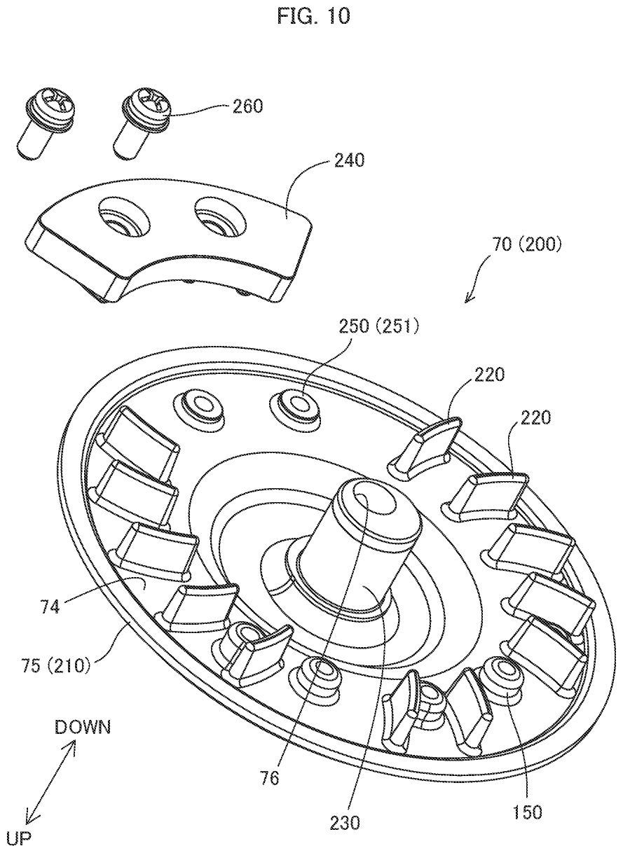

As illustrated in FIG. 6, the balancer 240 is attached to a circumferential part of the motor cooling fan 200 (a region without the second blades 220 formed thereon). More specifically, a threaded boss 250 is formed on the main plate 71. As illustrated in FIGS. 7 and 10, the threaded boss 250 protrudes downward and upward on both one side where the dust collection fan 200 is located and the other side where the motor cooling fan 100 is located, respectively. The threaded boss 250 protruding downward on the one side where the dust collection fan 200 is located will also be referred to as a threaded boss 251 (refer to FIG. 10). The threaded boss 250 protruding upward on the other side where the motor cooling fan 100 is located will also be referred to as a threaded boss 252 (refer to FIG. 7).

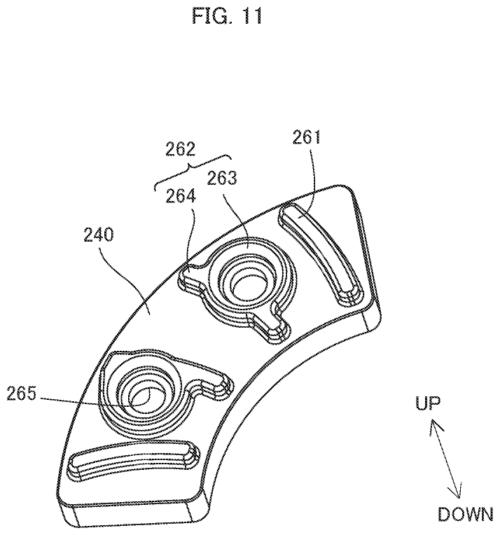

As illustrated in FIG. 11, the balancer 240 includes two through-holes 265. The through-holes 265 are formed at positions corresponding to two threaded bosses 251 of the dust collection fan 200. The balancer 240 further includes, on the upper surface thereof, protrusion portions 261 and 262 protruding upward (toward the dust collection fan 200). The protrusion portion 261 extends generally radially and elongatedly. The protrusion portion 262 includes a fitted protrusion portion 263 and a rectification protrusion portion 264. The fitted protrusion portion 263 is formed annularly so as to surround the through-hole 265 therearound, and is shaped and sized in such a manner that the outer periphery of the threaded boss 251 of the dust collection fan 200 is fitted therein. The rectification protrusion portion 264 extends generally radially from the fitted protrusion portion 263.

To attach the balancer 240 to the dust collection fan 200, first, the balancer 240 is placed in such a manner that the threaded boss 251 of the dust collection fan 200 is fitted inside the fitted protrusion portion 263. According to this method, the balancer 240 can be accurately and easily positioned relative to the dust collection fan 200. Then, the balancer 240 is fixed to the dust collection fan 200 as illustrated in FIG. 6 by inserting bolts 260 into the threaded bosses 251 from below so as to place them through the through-holes 265 of the balancer 240 and tightening them.

At this time, the upper surfaces of the protrusion portions 261 and 262 are in abutment with the second surface 74 of the main plate 210 of the dust collection fan 200. Due to that, a space 270 is defined between the balancer 240 and the main plate 210 as illustrated in FIG. 6. The space 270 functions as a flow passage when the air flows according to the above-described route for dust collection. In other words, in the circumferential region where the balancer 240 is disposed, the air flowing into the containing space 28 via the holes 44 of the pad 41 and hitting against the main plate 210 is exhausted radially outward via the space 270. For this reason, the space 270 will also be referred to as a flow passage 270.

According to such a configuration, even when the motor shaft 61 (and thus the dust collection fan 200 and the balancer 240) is rotated and the balancer 240 is located at a position radially facing the inlet 29a of the dust collection passage 29, the air flowing into the containing space 28 via the holes 44 of the pad 41 and hitting against the main plate 210 is exhausted radially outward via the flow passage 270. Therefore, compared to a configuration in which the flow passage 270 is not defined, a pressure change in the air around the inlet 29a is reduced between when the second blades 220 of the dust collection fan 200 are located at the position facing the inlet 29a and when the balancer 240 is located at the position facing the inlet 29a. As a result, the generation of noise is reduced. In addition, the provision of the flow passage 270 also allows the dust to be guided radially outward together with the air, thereby contributing to reducing the accumulation of dust in a space between the balancer 240 and the dust collection fan 200.

In addition, according to the above-described configuration, the flow passage 270 can be defined with a simple structure using the protrusion portions 261 and 262 of the balancer 240. However, the flow passage 270 between the balancer 240 and the dust collection fan 200 can be defined by any method. For example, a spacer may be provided between the balancer 240 and the dust collection fan 200.

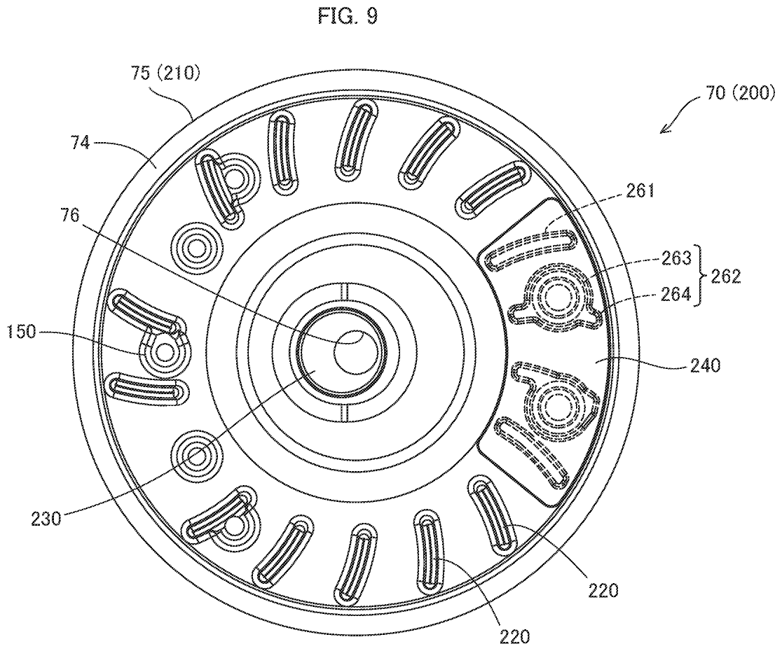

Further, the protrusion portion 261 extends generally radially, and the rectification protrusion portion 264 also extends in a radial range similar to the protrusion portion 261 in cooperation with a part of the fitted protrusion portion 263. Therefore, the protrusion portions 261 and 262 also function as a rectifier that directs the flow of the air in the flow passage 270 radially outward. This promotes the flow of the air directed radially outward in the flow passage 270, thereby succeeding in further reducing the generation of noise and the accumulation of dust. In addition, as illustrated in FIG. 9, the protrusion portions 261 and 262, which function as the rectifier, are disposed so as to intersect with the radial direction in the same direction as the second blades 220 of the dust collection fan 200. This further promotes the radially outward flow of the air in the flow passage 270.

Further, according to the above-described configuration, the motor cooling fan 100 and the dust collection fan 200 are integrally formed, and therefore the number of parts and the number of assembling processes of the sander 10 can be reduced. However, the motor cooling fan 100 and the dust collection fan 200 may be different separate members. In this case, the motor cooling fan 100 and the dust collection fan 200 may be disposed adjacent to each other or may be disposed at an axial interval therebetween.

Further, according to the above-described configuration, the protrusion portions 261 and 262 are formed on the balancer 240, and therefore the weight of the balancer 240 can be increased by an amount corresponding to the weights of the protrusion portions 261 and 262 without changing the horizontal area of the balancer 240. As a result, the weight for generating a centrifugal force necessary to solve the static unbalance and the couple unbalance can be achieved with the horizontal compact area of the balancer 240. However, as the protrusion portion, a protrusion portion having a function similar to the protrusion portions 261 and 262 (a protrusion portion protruding from the main plate 210 toward the balancer 240) may be formed on the main plate 210 of the dust collection fan 200 instead of the balancer 240.

In the above-described embodiment, the fan 70 and the balancers 140 and 240 can be made from any material. For example, the balancers 140 and 240 may be made from metal (for example, made from heavy metal (for example, iron, zinc, copper, or an alloy containing any of them (for example, yellow brass))). The fan 70 may be made from a material lighter in specific gravity than the materials of the balancers 140 and 240 (for example, made from synthetic resin or light metal (for example, aluminum, magnesium, titan, or an alloy containing any of them)). Selecting the materials in this manner can increase the weight difference between the fan 70 and the balancers 140 and 240, thereby contributing to efficiently solving the static unbalance and the couple unbalance. Alternatively, the required weight difference can be secured with relatively small volumes of the balancers 140 and 240, and therefore the balancers 140 and 240 can be configured compactly.

Having described the embodiment of the present disclosure, the above-described embodiment is intended to only facilitate the understanding of the present teachings, and is not intended to limit the present invention thereto. The present disclosure can be modified or improved without departing from the spirit thereof, and the present disclosure includes equivalents thereof. Further, each of the elements described in the claims and the specification can be combined in any manner or omitted in any manner within a range that allows it to remain capable of achieving at least a part of the above-described objects or bringing about at least a part of the above-described advantageous effects.

For example, instead of the flow passage 270 defined between the main plate 210 of the dust collection fan 200 and the balancer 240, any kind of flow passage for exhausting the air radially outward may be formed at a circumferential position of the dust collection fan 200 between an edge portion of the dust collection fan 200 vertically opposite from the balancer 240 (i.e., the upper edge portion) and the balancer 240 at which position the balancer 240 is attached. For example, a generally radially extending recessed portion may be formed on the main plate 210 of the dust collection fan 200 and the inside of the recessed portion may function as a flow passage with the balancer 240 disposed on this recessed portion. Alternatively, in a case where the main plate 210 has a sufficient thickness, a recessed portion may be formed in a region of the main plate 210 on the radially inner side with respect to the balancer 240 at the circumferential position where the balancer 240 is disposed, and a lateral hole may be formed so as to be opened generally radially from the side surface of this recessed portion to the side surface of the main plate 210. Such a lateral hole can also fulfill a function equivalent to the above-described flow passage 270.

Further, in the case where the motor cooling fan 100 and the dust collection fan 200 are arranged coaxially like the above-described embodiment, the motor cooling fan 100 may include a configuration similar to the dust collection fan 200 (various configurations regarding the flow passage 270) instead of or in addition to the dust collection fan 200. Further, in a case where a spindle (an output shaft) interlocked with the motor shaft is disposed in parallel with the motor shaft and a motor cooling fan and a dust collection fan are mounted on the motor shaft and the spindle, respectively, a configuration similar to the dust collection fan 200 may be employed for this dust collection fan.

Further, the above-described embodiment can be applied to not only the random orbital sander but also various portable machining apparatuses accompanied by an eccentric circular motion. For example, the above-described embodiment can also be applied to orbit sanders, polishers, and the like.

The corresponding relationship between each component in the above-described embodiment and each component of the claims will be described below. However, each component in the embodiment is merely one example and shall not limit each component of the claims. The sander 10 is one example of a “portable machining apparatus.” The electric motor 60 is one example of a “motor.” The motor shaft 61 is one example of an “output shaft.” The tool accessory 40 is one example of a “tool accessory.” The motor cooling fan 100 is one example of a “motor cooling fan.” The dust collection fan 200 is one example of a “dust collection fan.” The balancer 240 is one example of a “balancer.” The flow passage 270 is one example of a “flow passage.” The main plate 210 is one example of a “main plate.” The second blades 220 are one example of a “plurality of blades” and a “plurality of second blades.” The protrusion portions 261 and 262 are one example of a “protrusion portion.” The first blade 120 is one example of a “first blade.” The second blade 220 is one example of a “second blade.” The first surface 72 is one example of a “first surface.” The second surface 74 is one example of a “second surface.” The threaded boss 251 is one example of a “threaded boss.” The through-hole 265 is one example of a “through-hole.” The bolt 260 is one example of a “threaded member.”

### DESCRIPTION OF THE REFERENCE NUMERALS

10 sander
11 housing
21 front housing portion
22 grip portion
23 rear housing portion
24 intake port
25 exhaust port
26 power source cord
27 switch button
28 containing space
29 dust collection passage
29a inlet
30 dust collection nozzle
31 dust bag
40 tool accessory
41 pad
42 flat surface
43 bolt
44 hole
45 space
46 communication hole
48 switch unit
60 electric motor
61 motor shaft
62, 63, 64 bearing
65 controller
66 threaded hole
67 plate
68 bolt
69 bearing box
70 fan
71 main plate
72 first surface
73 upper-side portion
74 second surface
75 lower-side portion
76 shaft insertion hole
100 motor cooling fan
110 main late
120 first blade
140 balancer
150 threaded boss
160 bolt
200 dust collection fan
210 main plate
220 second blade
230 shaft portion
240 balancer
250, 251, 252 threaded boss
260 bolt
261, 262 protrusion portion
263 fitted protrusion portion
264 rectification protrusion portion
265 through-hole
270 flow passage (space)

What is claimed is:

1. A portable machining apparatus comprising:
a motor;
an output shaft extending in an axial direction and configured to be rotated by a rotational driving force of the motor;
a tool accessory configured to perform an eccentric circular motion in response to the rotation of the output shaft;
a dust collection fan fixed to the output shaft so as to circumferentially surround the output shaft;
a motor cooling fan configured to be rotated by the rotational driving force of the motor; and
a balancer attached to at least one fan of the dust collection fan and the motor cooling fan,
wherein a flow passage is defined so as to radially outward exhaust air flowing in the axial direction toward the at least one fan at a circumferential position of the at least one fan between an edge portion of the at least one fan opposite from the balancer in the axial direction and the balancer at which position the balancer is attached.

2. The portable machining apparatus according to claim 1, wherein the at least one fan includes a main plate and a plurality of blades generally radially extending at least partially on one of surfaces of the main plate,
the one of the surfaces is a surface on one side of the main plate where the balancer is located, and
the flow passage is defined between the one of the surfaces of the main plate and the balancer.

3. The portable machining apparatus according to claim 2, wherein one of the main plate and the balancer includes a protrusion portion extending toward the other of the main plate and the balancer and placed in abutment with the other of the main plate and the balancer, and
a space functioning as the flow passage is defined between the main plate and the balancer using the protrusion portion.

4. The portable machining apparatus according to claim 3, wherein the protrusion portion is shaped to function as a rectifier for radially outward directing a flow of the air in the flow passage.

5. The portable machining apparatus according to claim 4, wherein each of the plurality of blades at least partially and generally radially extends so as to intersect with a radial direction, and
the protrusion portion is disposed so as to intersect with the radial direction in the same direction as the plurality of blades.

6. The portable machining apparatus according to claim 3, wherein the balancer includes the protrusion portion.

7. The portable machining apparatus according to claim 1, wherein the dust collection fan and the motor cooling fan are in the form of an integrated single fan including a main plate including a first surface and a second surface opposite from the first surface, a plurality of first blades radially extending at least partially on the first surface, and a plurality of second blades radially extending at least partially on the second surface.

8. The portable machining apparatus according to claim 1, wherein the balancer is made from metal, and
the at least one fan is lighter in specific gravity than the balancer.

9. The portable machining apparatus according to claim 6, wherein the at least one fan includes a threaded boss protruding toward the balancer,
the balancer includes a through-hole formed at a position corresponding to the threaded boss,
the protrusion portion protrudes toward the at least one fan around the through-hole, and is shaped and sized in such a manner that an outer periphery of the threaded boss is fitted therein, and
the at least one fan and the balancer are fixed to each other using a threaded member inserted in the through-hole and the threaded boss.

10. The portable machining apparatus according to claim 3, wherein the balancer includes the protrusion portion.

11. The portable machining apparatus according to claim 4, wherein the balancer includes the protrusion portion.

12. The portable machining apparatus according to claim 2, wherein the dust collection fan and the motor cooling fan are in the form of an integrated single fan including a main plate including a first surface and a second surface opposite from the first surface, a plurality of first blades radially extending at least partially on the first surface, and a plurality of second blades radially extending at least partially on the second surface.

13. The portable machining apparatus according to claim 3, wherein the dust collection fan and the motor cooling fan are in the form of an integrated single fan including a main plate including a first surface and a second surface opposite from the first surface, a plurality of first blades radially extending at least partially on the first surface, and a plurality of second blades radially extending at least partially on the second surface.

14. The portable machining apparatus according to claim 4, wherein the dust collection fan and the motor cooling fan are in the form of an integrated single fan including a main plate including a first surface and a second surface opposite from the first surface, a plurality of first blades radially extending at least partially on the first surface, and a plurality of second blades radially extending at least partially on the second surface.

15. The portable machining apparatus according to claim 5, wherein the dust collection fan and the motor cooling fan are in the form of an integrated single fan including a main plate including a first surface and a second surface opposite from the first surface, a plurality of first blades radially extending at least partially on the first surface, and a plurality of second blades radially extending at least partially on the second surface.

16. The portable machining apparatus according to claim 4, wherein the balancer includes the protrusion portion, and
the dust collection fan and the motor cooling fan are in the form of an integrated single fan including a main plate including a first surface and a second surface opposite from the first surface, a plurality of first blades radially extending at least partially on the first surface, and a plurality of second blades radially extending at least partially on the second surface.

17. The portable machining apparatus according to claim 2, wherein the balancer is made from metal, and
the at least one fan is lighter in specific gravity than the balancer.

18. The portable machining apparatus according to claim 3, wherein the balancer includes the protrusion portion,
the at least one fan includes a threaded boss protruding toward the balancer,
the balancer includes a through-hole formed at a position corresponding to the threaded boss,
the protrusion portion protrudes toward the at least one fan around the through-hole, and is shaped and sized in such a manner that an outer periphery of the threaded boss is fitted therein, and
the at least one fan and the balancer are fixed to each other using a threaded member inserted in the through-hole and the threaded boss.
